(19) United States
(12) Patent Application Publication
(10) Pub. No.: US 2026/0254251 A1
(43) Pub. Date: Aug. 27, 2026

(54) TRACKING AND CONTROLLING RENEWABLE ENERGY STORAGE AND DISCHARGE TO ACHIEVE A GOAL

(71) Applicant: PEP Development Services, LLC, Houston, TX (US)

(72) Inventors: Alec Miller, Glendale, CA (US); Roshan Neil Livingstone, Pasadena, CA (US); Abhinaav Singh, Pasadena, CA (US); Siddhesh Bhande, Glendale, CA (US); Scott Burns, Maplewood, NJ (US)

(21) Appl. No.: 19/531,565

(22) Filed: Feb. 5, 2026

Related U.S. Application Data
(60) Provisional application No. 63/761,594, filed on Feb. 21, 2025.

(51) Int. Cl. H02J 3/38; H02J 3/28; H02J 101/20

(52) U.S. Cl. CPC H02J 3/381; H02J 3/28; H02J 2101/20

(57) ABSTRACT

A reservoir status data of an energy storage device is received, including a state of charge and a quantity or proportion of charge from renewable energy sources. A load data associated with a load is received. A carbon data associated with energy supplied to a load is received. The reservoir status data, load data, and carbon data are used to determine based at least in part on a carbon goal associated with the energy storage device an amount of energy to be discharged from the energy storage device to service the load. The determined amount of energy is dispatched from the energy storage device to service the load. The reservoir status data of the energy storage device is updated based on the amount of energy discharged from the storage device to service the load and the carbon goal.

### CROSS REFERENCE TO OTHER APPLICATIONS

This application claims priority to U.S. Provisional Patent Application No. 63/761,594 entitled TRACKING AND CONTROLLING RENEWABLE ENERGY STORAGE AND DISCHARGE TO ACHIEVE A GOAL filed Feb. 21, 2025 which is incorporated herein by reference for all purposes.

### BACKGROUND OF THE INVENTION

Renewable energy generation is a primary form of new energy generation deployed globally. Advantages of renewable energy generation include its cost, its zero carbon emissions footprint, and that it can be built relatively quickly and distributed across many locations. One challenge of renewable energy generation such as photovoltaic generation and/or wind generation is its intermittent nature, in that the sun does not shine nor the wind blow at every hour of a day for a given generation location. Energy storage technology mitigates this intermittent nature by allowing renewable energy to be stored when it is available and discharged at other times when it is not.

The zero carbon emissions footprint of renewable energy generation at least in part reduces the effect of ecological degradation from overall energy production, improving the quality of life and life expectancy of all living species on the planet. A consumer such as an individual or corporation may reduce their share of ecological degradation from energy production given political, regulatory, or economic incentives. Such incentives typically require accounting, tracking, and controlling of their share of ecological degradation from energy production, for example their share of carbon footprint based on the carbon intensity of the energy consumed. More efficient and/or effective accounting, tracking, and controlling may improve the incentives for consumers to improve the quality of life and life expectancy of all living species on the planet.

### BRIEF DESCRIPTION OF THE DRAWINGS

Various embodiments of the invention are disclosed in the following detailed description and the accompanying drawings.

FIG. 1 is a functional diagram illustrating a programmed computer/server system for facilitating per period tracking of renewable energy storage/discharge in accordance with some embodiments.

FIG. 2 is a block diagram illustrating an embodiment of an energy storage management system.

FIG. 3 is an example of a screenshot rendering of an input screen for setting renewable percentages on a periodic basis.

FIG. 4 is an example illustration of a target green allocation.

FIG. 5A is a screenshot illustrating an example of discharge slices.

FIG. 5B is a screenshot illustrating a first example of a discharge slice.

FIG. 5C is a screenshot illustrating a second example of a discharge slice.

FIG. 6A illustrates a “Green First” allocation (502) wherein any renewable charge within a battery is discharged before any nonrenewable energy is discharged.

FIG. 6B illustrates a “Target Green First” allocation (512) wherein each discharge contains 50% renewable and 50% nonrenewable energy.

FIG. 7 is a block diagram illustrating an embodiment of an energy storage management system for controlling storage and discharge to meet carbon goals.

FIG. 8 is a block diagram illustrating an embodiment of an energy storage management system for controlling storage and discharge to co-optimize for carbon and pricing goals.

FIG. 9 is a flow diagram illustrating an embodiment of a process for tracking and controlling renewable energy storage and discharge to achieve a goal.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Tracking and controlling renewable energy storage and discharge, such as that in a battery, is disclosed. The tracking and controlling is used to achieve a goal, such as a carbon goal and/or pricing goal.

Per Period Tracking. Consumers of a renewable energy source may provide incentive accounting for their use of renewable energy by determining when renewable generation has occurred, when the generated energy has been consumed, and tracking this generation/consumption on an hourly basis. When these consumers use energy storage, however, the carbon emissions footprint attributes of energy may be accounted for as it is produced, charged into an energy storage device, held for a period of time which may vary, and then discharged for consumption by a load. If the battery is charged with both energy that has a carbon intensity, such as grid sourced energy, and with renewable energy, distinguishing which type and source of energy is discharged at what time is important. Determining the sources of energy which were consumed at which time for consumers of energy with an energy storage device is disclosed. This comprises periodically tracking the renewable energy storage in a battery and a mechanism for intentionally allocating the discharge records.

Per period tracking of renewable energy storage and discharge for a consumer is disclosed. A consumer such as a data center associated with a technology company may have social, political, regulatory, or economic concerns that the energy powering the data center has a high carbon intensity. Such concerns may be addressed using an accounting of a consumer of their carbon intensity based on the source of the energy that was consumed. However, coarse accounting, for example based on days, weeks, or months, may bring further concerns that per period tracking is necessary to account for nuance such as the fact that photovoltaic generation only works when sunlight is available, and that electricity is generally fungible. As referred to herein, fungible refers to the commoditized nature of electrons that have no ordering. For example, if a battery is periodically charged from a coal-fired power plant and also periodically charged from a photovoltaic array, the electrons themselves are not identifiable as to their source and their carbon intensity. Furthermore, unlike a collection of discrete items being pulled in and out of a ‘queue’ or ‘stack’, there is no FIFO (First In First Out), LIFO (Last In First Out), or any ordering to these electrons and, for example, the zero carbon electrons that a photovoltaic array charges a battery with are not extracted “first” merely because the photovoltaic array charged the battery last.

Carbon intensity and carbon emissions retain social, political, regulatory, or economic concerns so that regardless of the actual source of electricity, a parallel accounting is that of legal claims on an electrical source. In particular, renewable energy and/or zero carbon energy has a legal accounting that addresses concerns, for example in the United States via certificates to purchase a right to a measure of the renewable energy that typically gives a consumer rights to one Watt-hour of renewable energy claim. This is especially the case with grid energy with a mix of sources depending on the grid supplier and the time of day/week/month/year. Certificates are an example of a book and claim accounting for energy, wherein as referred to herein book and claim refers to any accounting system that decouples environmental/legal aspects of renewable energy from the physical energy itself, allowing asset purchasers to claim sustainability benefits without direct physical receipt of the energy.

Generic tracking, for example a data center consumer, purchasing certificates from a grid source and additional renewable certificates from a local photovoltaic panel source, presents an accounting that for example permits the consumer to state that 70% of their energy source is renewable. Such a generic statement may call into question and/or bring criticism of greenwashing and oversimplifying energy sourcing techniques because 70% of their energy source at night is not renewable when the photovoltaic panel source brings no energy.

Per period tracking, such as hourly tracking, is an improvement in accounting that more appropriately determines the “greener” or lower ecological degradation in energy sourcing for a consumer. Per period tracking enables tracking the carbon footprint of an energy storage device and a load, when a load is served by multiple sources of energy such as energy with zero carbon such as renewables or nuclear, and energy containing carbon such as fossil fuel generated energy typically supplied by the grid or onsite reciprocating engines/turbines, when an energy storage device is used to supply some or all of the energy to meet the load. Per period tracking provides a more accurate method of knowing when and how much renewables are dispatched by an energy storage device coupled to a consumer. That is, hourly-aligned renewable consumption tracking enables more genuine round-the-clock energy consumption accounting than a simplistic “100% annual renewable” claim.

Exploding Slice Problem. Per period tracking enables greater insight into multisource loads. In one embodiment, during daylight hours a load's energy storage device charges with more “green” energy with zero carbon intensity such as from photovoltaics and less “grey” energy containing carbon. A naïve approach after the sun goes down may be to discharge “green first” where all green energy in the energy storage device ledger is accounted for as discharged first, to showcase a consumer's lower carbon footprint aggressively. However, this has a side effect that leaving grey energy in the energy storage device ledger too long intensifies and causes the carbon intensity to rise, for example because as losses are applied to the battery, those losses are applied across the battery. As referred to herein, battery losses refers to resistive losses and self-discharge losses for a battery that for a given source reduce the energy to be discharged from the battery in comparison to the energy charged to the battery. For example if a photovoltaic source charges a battery from 0 kWh to 100 kWh, then for a given battery only 99.95 kWh may be available for discharge due to resistive losses and/or self discharge losses.

For example, energy slices which have carbon associated with them may grow in carbon intensity if left in the energy storage device for longer periods of time. The mass of carbon does not change and without discharge it accumulates losses assigned to the energy slice due to self-discharge losses in terms of grams of carbon dioxide per Watt-hour with a reduced number of Watt-hours as denominator, and it becomes detrimental to actually discharge it and incur the carbon cost. As referred to herein, this problem is the exploding slice problem because of the explosion of carbon intensity when burying grey energy within an energy storage device ledger. As referred to herein, an energy slice is a unit of accounting that comprises information about the carbon content within a source of energy. An energy slice comprises one or more of the following:
the amount of energy within the slice;
the carbon intensity of the slice; and
source of energy.

An energy slice when attributed to a charge record and/or discharge record gives it one or more timestamp attribute(s).

For example, a battery has a charge of 50 kWh at 2025-01-02 at 12:03. At that time, 20 kWh came from the grid G1 with a blended carbon content of 100 g/kWh, and 30 kWh came from solar photovoltaic panels farm PV1 generated at 0 g/kWh. There are thus two slices:
1. Slice 1: {20 kWh energy; 2,000 g carbon; G1 source}
2. Slice 2: {30 kWh energy; 0 g carbon; PV1 source}

Two charge records are created, both at 2025-01-02 at 12:00, for each slice that goes into the battery:
1. Charge Record A1: {Slice 1, 2025-01-02 at 12:03}
2. Charge Record A2: {Slice 2, 2025-01-02 at 12:03}

During discharge, the discharge records reference charge records, for example a discharge of 10 kWh at 2025-01-03 23:00 with an allocation of 90% for zero carbon:
1. Discharge Record D1: {Charge A1, 1 kWh, 2025-01-03 at 23:00}
2. Discharge Record D2: {Charge A2, 9 kWh, 2025-01-03 at 23:00}

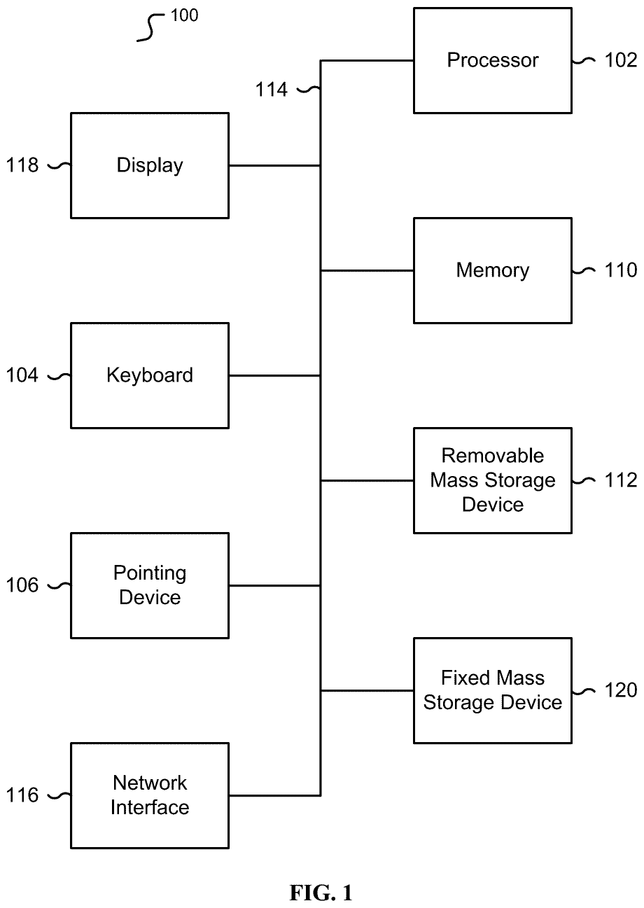

FIG. 1 is a functional diagram illustrating a programmed computer/server system for facilitating per period tracking of renewable energy storage/discharge in accordance with some embodiments. As shown, FIG. 1 provides a functional diagram of a general-purpose computer system programmed to facilitate per period tracking of renewable energy storage/discharge with some embodiments. As will be apparent, other computer system architectures and configurations can be used for facilitating per period tracking of renewable energy storage/discharge.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

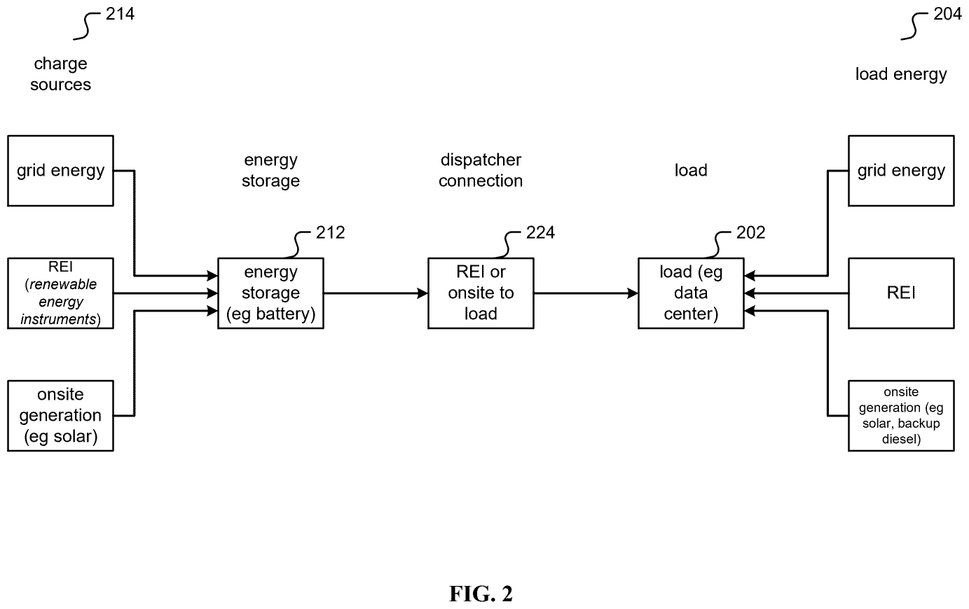

FIG. 2 is a block diagram illustrating an embodiment of an energy storage management system. In one embodiment, one or more of the blocks in FIG. 2 may be made up of a fraction, one, or plurality of systems similar to that depicted in FIG. 1.

As shown in FIG. 2, a consumer without limitation may refer to an end-consumer with a load as well as intermediaries providing one or more loads, one or more energy storage devices, and/or one or more connections. Without limitation, a consumer system may have more loads, sources, and batteries, and/or may have fewer loads, sources, and batteries as that depicted in FIG. 2.

Load (202) requires electrical power to consume in order to carry out its operation. An example of a load (202) is a data center. A load (202) as referred to herein is any fixed or variable load that consumes energy-either in electricity measured in Watt-hours, fuel such as hydrogen or natural gas, thermal, or mechanical form.

In one embodiment, the load (202) is coupled to a load energy (204) source such as grid energy, onsite generation like solar photovoltaic panels but also backup diesel generators, and renewable energy instruments (REI). As referred to herein, an REI is a tradeable asset that may be decoupled from physical generation indicating an aspect of renewable energy generation for renewable energy accounting. As referred to herein, a registry is a record manager of certificates or GO actions, for example, certificate creation, transfer, and/or surrender, typically maintained as a central record for multiple parties. In one embodiment, a registry is based at least in part on a blockchain.

A first example of an REI is a certificate, which as referred to herein is an environmental attribute certificate or Guarantee of Origin (GO), which may be time based (e.g. annual, monthly, hourly) reflecting the time the underlying renewable energy was produced and could be location based (e.g. Electric Reliability Council of Texas, a.k.a. ERCOT) reflecting the location where the underlying energy was produced. A second example of an REI is a power purchase agreement (PPA) including longer-term contracts to purchase renewable energy and associated certificates, including physical PPAs with direct energy delivery and certificate ownership or virtual PPAs with financial settlement based on energy prices and certificate ownership. Other examples include Guarantees of Origin (“GOs”, or Granular Certificates (“GCs”, which are hourly time stamped certificates, or Time based Environmental Attribute Certificates “TEACS”, which are hourly time stamped certificates.

In one embodiment, similar to the load (202), an energy storage device (212) is coupled to charge sources (214) such as grid energy, onsite generation like solar photovoltaic panels, and REI. As referred to herein, an energy storage device (212) is an device storing energy of any type, for example a battery, pumped hydro, compressed air, thermal storage, and hydrogen storage. The energy storage device (212) may be standalone, or co-located with the load (202) and/or onsite generation (204)/(214), front of grid meter or behind grid meter.

Between load (202) and energy storage (212) is a connection via dispatcher (224). As referred to herein, a dispatcher is a stand-alone optimizer and/or dispatcher system, which has control over charging/discharging of an energy storage device (212). A dispatcher may use Carbon Tracking Software (CTS) which as referred to herein is software which identifies and/or tracks the carbon intensity of consumption and/or generation across one or multiple sites and/or assets, and which may be stand-alone or may be integrated with a dispatcher. The dispatcher may be a module or group of functions separate or within a CTS system and may consider energy prices as one of its inputs.

The dispatcher may optimize a carbon goal which as referred to herein is a goal based on renewable percentage, carbon intensity (CI), Carbon Free Energy (CFE) scoring, or any known method of tracking the carbon usage of a load. In one embodiment, a price may be assessed for carbon, such as a market price per ton. Alternately, for a net zero target, a very high price may be assessed for carbon. The dispatcher may also optimize a pricing goal which as referred to herein is an energy trading goal focused on optimizing the storage device (212) economic returns from participating in energy trading, which may include generally known methods of trading energy, such as day ahead or ancillary services.

The energy storage management system may comprise remote nodes in one or more blocks of FIG. 2, such as computers having network or other communication interfaces configured to access metering or other equipment on site, for example to track energy coming into a storage device (charge records) and its source (for example, renewable or nonrenewable), the state of charge of each storage device, and the energy discharged from each storage device (discharge records) to each load. The system may also include one or more processors configured to control storage device discharge, like a dispatcher (224), and/or implement techniques disclosed herein, and manage storage devices to store records and/or data.

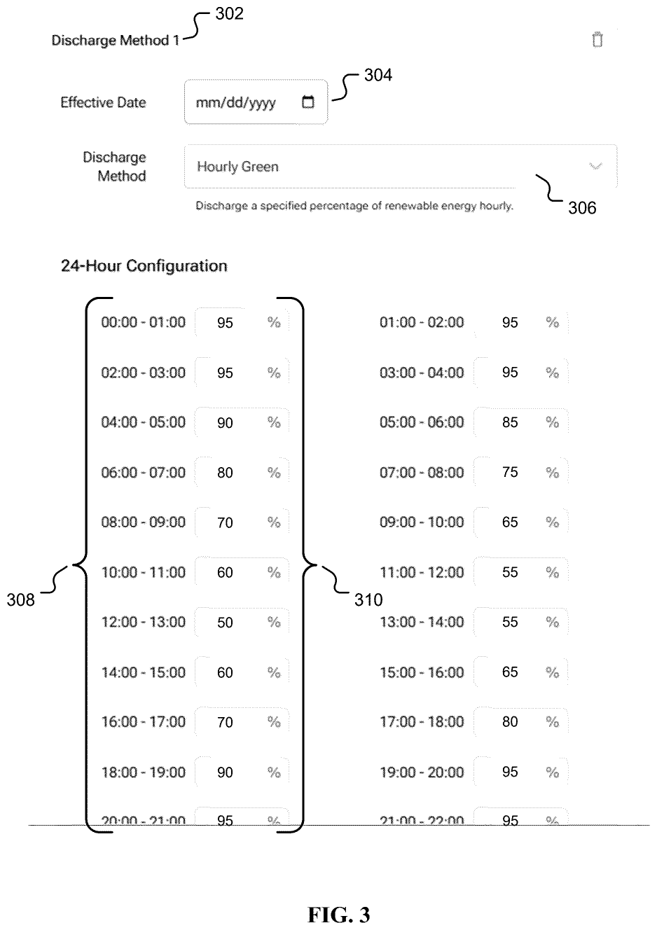

FIG. 3 is an example of a screenshot rendering of an input screen for setting renewable percentages on a periodic basis. In one embodiment, the input screen of FIG. 3 is an example of a user interface for the system of FIG. 1 and/or the dispatcher (224) of FIG. 2.

In one embodiment, setting renewable percentages on a periodic basis includes an identifier (302), such as “Discharge Method 1”, and effective date (304), and the discharge method itself (306), which as “hourly green” may comprise a template for specifying a discharge percentage of renewable energy hourly. Other methods (306) may include FIFO, LIFO, and/or a weighted average as referenced in standards such as the EnergyTag TM standards. A 24-hour configuration for specifying a discharge percentage of renewable energy hourly is then shown with hours (308) and settable discharge percentages (310). In one embodiment not shown, discharge units such as Watt-hours are used instead of discharge percentages. In the example of FIG. 3, percentages (310) are shown to increase renewable energy when the sun is down and a local photovoltaic panel source is dormant, and decrease renewable energy when the sun is up and/or load demand is higher.

Target Green. In one embodiment, one discharge method (306) is a target green method, referred to herein as a method and/or system by which a green energy goal is set, for example, as the percentage of renewables discharged on an hourly basis. Without limitation, the goal may not be expressed in percentage, and may be any means of intentionally discharging renewables, for example Watt-hours of renewables, carbon intensity, and/or energy type such as solar or hydroelectric.

In one embodiment, the target green hourly method allows the user or system to intentionally discharge a certain amount or percentage of renewables per time period, typically an hour, but without limitation other available time periods are by minute, second, millisecond, or microsecond.

A target green method is an improvement to other methods such as FIFO, LIFO, or weighted average, which while convenient from an accounting perspective, do not allow storage device operators/algorithms/dispatcher (224) to intentionally discharge renewable energy when needed. Again, these methods of FIFO, LIFO, and weighted average are referenced in the EnergyTag TM standards but may suffer from this challenge. For example, if using FIFO, it is not possible to know, without reviewing the storage device reservoir at each interval, what type of energy, such as green or carbon intensive, is coming out next. Additionally, if the FIFO method has determined that carbon intensive slices will be discharged next, then it is not possible to intentionally discharge renewable slices until the carbon intensive slices have been discharged. Thus FIFO, LIFO, and weighted average are impractical for a battery operator without controlling inputs with an inordinate amount of processor, storage, network, and user resources.

In one embodiment, setting the target green percentage to less than 100% for a portion of the time, for example each hour, has an advantage of discharging at least some carbon in the storage reservoir (212), which reduces the exploding slice problem of ever-increasing carbon intensity over time as losses are incurred.

In one embodiment, target green comprises one or more of the following aspects:
1. A percentage allocation between renewable and nonrenewable energy is set as a target. Note that this may be allocated after or before energy is generated, discharged, and/or consumed ex-post (“after the fact”) and/or dynamically set;
2. Nonrenewable energy slices in the reservoir may be ordered by their carbon intensity. In one embodiment, higher carbon intensity slices are ordered to discharge first;
3. For each discharge volume and for a given hour, the percentage allocation for that hour is followed, discharging both the target percentage of renewables and nonrenewable slices. For example, if one hour's target is set to be 75% of renewable energy and 25% of nonrenewable energy, both types of energy are discharged for the hour, assuming they are available in the storage reservoir. In one embodiment, the target green enables a setting such that the slices with highest carbon intensity are discharged first for the nonrenewable target percentage;
4. In one embodiment, the target green enables a setting that in the event a given storage device cannot meet the set renewables target because there is not enough renewable energy remaining in the storage device, nonrenewable energy slices from the storage device are used to make up the difference. In one embodiment, the target green enables a setting such that the nonrenewable energy slices are discharged in the descending order of their carbon intensities.

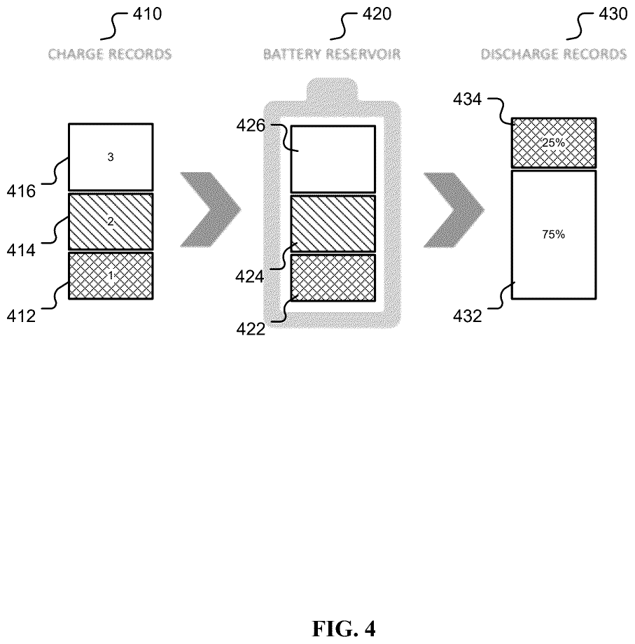

FIG. 4 is an example illustration of a target green allocation. In one embodiment, the example of FIG. 4 illustrates an allocation shown from 07:00 to 08:00 in FIG. 3 of 75% renewables allocation.

As shown in FIG. 4, for a given energy storage (212) such as that in FIG. 2, there are charge records (410), a battery reservoir (420), and discharge records (430). As referred to herein, a charge record is an accounting of the energy that charges an energy storage device, and as referred to herein, a discharge record is an accounting of the energy that is discharged from an energy storage device. In one embodiment, a charge record and/or discharge record may be reconciled with an energy/power meter on the input or output of the energy storage device (420) wherein the meter has energy flows that indicate how much energy was input and/or output to the energy storage device (420) for a given hour.

As shown in FIG. 4, as of a recent state of the battery reservoir (420) what charge records (410) demonstrate is that there are Watt-hours from a nonrenewable source with higher carbon intensity (412) indicated by a crosshatched fill for example coal, there are Watt-hours from a nonrenewable source with lower carbon intensity (414) indicated by a diagonal fill for example nuclear, and there are Watt-hours from a renewable source with zero carbon intensity (416) indicated by a clear fill. In the simple of example of FIG. 4, the charge records (410) are all that has charged the battery reservoir (420) so there is a corresponding proportion of charge that is sourced nonrenewable/higher carbon intensity (422) indicated by a crosshatched fill, nonrenewable/lower carbon intensity (424) indicated by a diagonal fill, and renewable/zero carbon intensity (426) indicated by a clear fill.

For 07:00 to 08:00 in FIG. 3, a 75% renewables allocation is asserted so that discharge records for that hour are 75% renewable/zero carbon intensity (432) and 25% nonrenewable, here shown to be the higher carbon intensity (434).

As referred to herein, a granular certificate is a certificate-style accounting that tracks energy transactions with periodic intervals, say hourly or by-the-minute intervals, and may include, for example geographic location. An example of a granular certificate is a certificate comprising at least one of the following fields:
An issuance identifier or other unique identifier. For example, an identifier may be associated with a certain registry;
A start date indicating the start of the period, for example 1720771200 which in the Unix timestamp format is 2024-07-12 08:00:00 UTC;
An end date indicating the start of the period, or a duration of the period, for example 1 hour. Another example is 1720774800 which in the Unix timestamp format is 2024-07-12 09:00:00 UTC; and
A value in Watt-hours, for example 1250 Wh, which may also be shown in bundles of kWh, or MWh

The granular certificate may be used for generation, storage, and/or consumption with the start date/end date/period associated with the time of generation, storage/charge, and/or consumption/discharge. Other fields possible in a granular certificate include: a longitude/latitude location of an associated generator/storage/consumer, for example the location for a solar park generator that generated the energy associated with a specific granular certificate; a capacity of an associated generator/storage/consumer, a measure of carbon intensity; and/or a validity period and/or watermark.

In one embodiment, for a given energy storage device (420) the coupling of a charge record/discharge record with granular certificates for the energy storage device (420) provides the map of renewable energy over a period as shown in the battery reservoir (420) with charges of varying carbon intensity (422), (424), (426).

An example of a representation of a corresponding energy slice within an energy storage device for a given hour comprises at least one of the following fields:
A source or fuel, for example “solar” or “nuclear”;
A volume of energy, for example 12930905.483323334 Wh;
A carbon intensity measure, for example CO2 of 0.0 grams of carbon dioxide per Watt-hour;
A meter identifier, for example “local propane generator”; and/or
An hour identifier, for example 1751292000 in Unix timestamp or Monday, Jun. 30, 2025 7:00:00 AM GMT-07:00 DST.

Example of Data Center. A data center is associated with a flat load in contrast to an HVAC facility with air conditioning that engages a compressor periodically resulting in high and low loads over a day. The data center is powered in part from the grid, wherein this utility company has an energy source content that draws from many gas turbines, which represent a higher carbon source. The data center management is incentivized to make their facility more ‘green’ and so prepares a budget for renewable energy certificates.

The management signs an agreement with a solar plant to offset carbon consumption numbers during the day with thousands of watt-hours of certificates from the solar plant during the day, matching it hour for hour. At night, however, the sun has gone down removing solar photovoltaic energy sources and the wind may also not blow for wind power generation, eliminating sources for renewable energy. The management thus needs to time shift energy through a battery or other energy storage device, so they purchase some solar Watt-hour certificates, put them in the battery, and discharge them later in the day.

One concern addressed with per-period tracking is that at night, there may be excess solar production globally, yet the extra solar may not be physically distributable to data center. So even if the data center management purchases 100% of their Watt-hours in solar certificates the physical reality is that there is a nighttime load from the data center that comes from the grid to physically support its consumption. Thus, the physical reality is that gas turbines are spinning and creating carbon to go up into the atmosphere even for a so-called 100% green data center. Put another way, if excess solar production is shunted to waste for the same hours when its representative granular energy certificates are traded, then physically carbon is still created to load the atmosphere. A per-period tracking is an improvement in reducing or removing this artificiality.

The management of the data center thus has claim to some green energy with the purchase of granular certificates, which may be matched with charge records of what has gone into the battery. While the energy which is discharged is fundamentally out of the control of the management because of the fungible nature of electricity, the discharge allocation of FIG. 3 and method of FIG. 4 permit the time shift of these granular certificates to a time when the discharge of the energy storage device has occurred.

Per-period tracking enables more accurate assessment of the carbon intensity of energy stored in the battery (420) and discharged to the load such as a data center. As renewable energy tracking regulatory bodies typically permit ex-post revisions, for example an overestimation of allocation where say 75% renewable energy allocation cannot be maintained for a given hour, such that management can go back and purchase more certificates that correspond to the given hour. In one embodiment, the energy storage management system prompts to adjust hourly percentage allocation (308), (310) based on a situation where such ex-post revisions are made.

Per-period tracking enables more accurate assessment of improved energy storage device (420) capacity for a given data center and given energy sourcing. For example, while a battery (420) may appear suitable for a data center owned solar array, per-period tracking may reveal that the battery (420) capacity is below optimal because it is not large enough to time shift enough renewable energy to take more advantage of solar photovoltaic power and/or reduce shunting solar power to waste.

In one embodiment, a battery (420) serves more than one load (202) of FIG. 2. Thus the dispatcher (224) may create new discharge records that are timestamped hourly for distribution to a plurality of loads (202) and/or distribution. In one embodiment, the creation of new hourly discharge records cancels the charge records as they apply only to the battery (420), less any losses in the battery. These new hourly discharge records replacing the charge records themselves are tradeable assets, and the energy storage management system may enhance said hourly discharge records with a carbon intensity value and/or energy source to facilitate stronger per-period tracking downstream. In one embodiment, the charge records are cancelled and discharge records are issued using a registry, for example an automated open-source hourly registry.

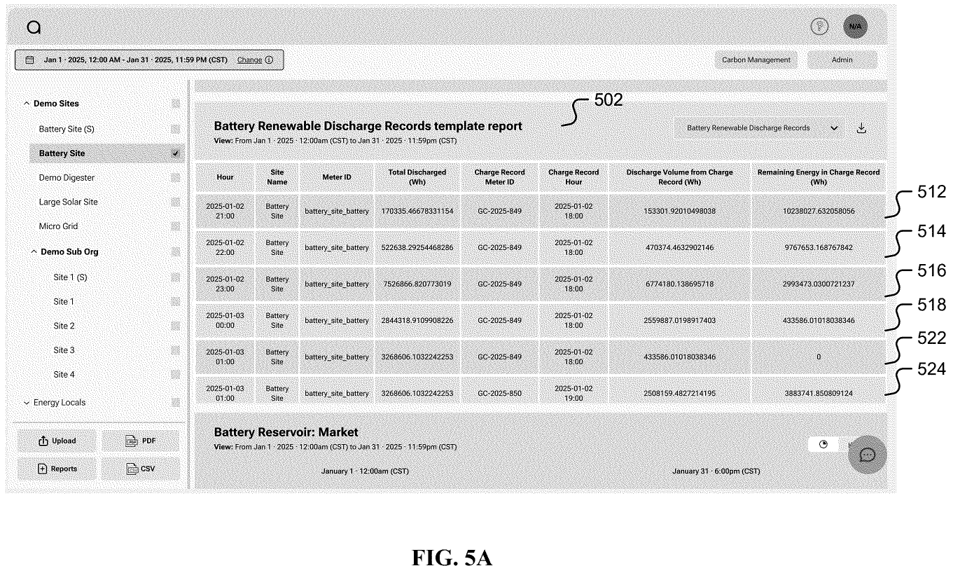

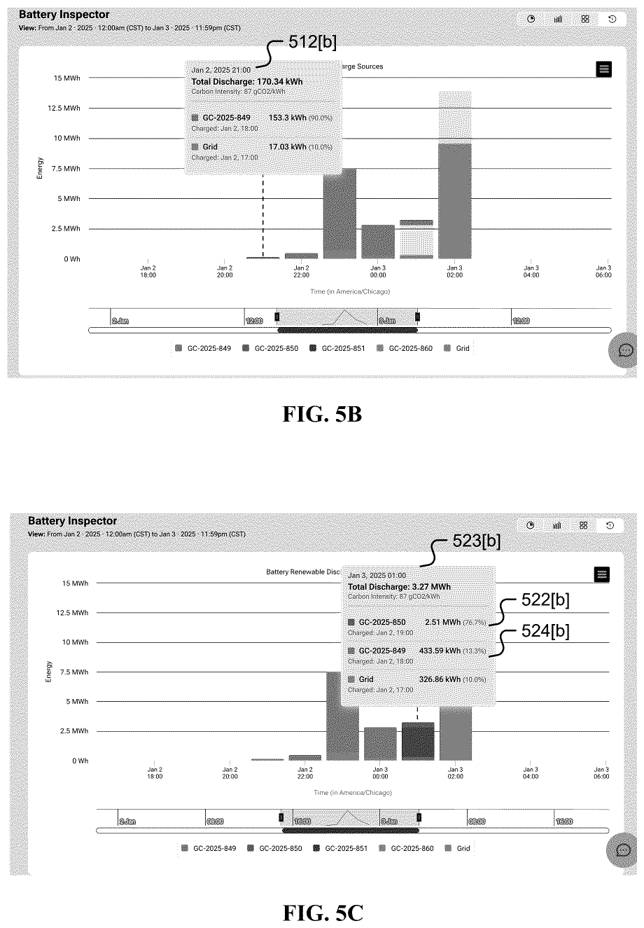

FIG. 5A is a screenshot illustrating an example of discharge slices. In one embodiment, the screenshot is rendered by the energy storage management system of FIG. 2 for the energy storage device (212). For the example shown in FIG. 5A, a target green discharge allocation method is used with a 90% renewable to 10% nonrenewable ratio.

As shown in FIG. 5A, a discharge records report (502) is made up of slices, each comprising one or more granular certificates. For example, the slice (512) for discharge hour 2025-01-2 21:00 of 170335.46678331154 Watt-hours is associated with a granular certificate GC-2025-849 which was charged on 2025-01-02 at 18:00. The discharge volume from the charge record was 153301.92010498038 Watt-hours, with the balance of 17033.54667833116 Watt-hours attributed to nonrenewable energy slices not listed in the discharge records report (502).

For example, a report of the “grey” or “non-green” Battery Nonrenewable Discharge Record, if they were to be accounted for, corresponding to the Renewable Discharge Record (502) in FIG. 5A may render as shown in Table I:

TABLE I
Battery Nonrenewable Discharge Records corresponding to FIG. 5A

| | | | | | Charge | Discharge Volume | Remaining |
|---|---|---|---|---|---|---|---|
| | Site | | Total Discharged | Charge Record | Record | from Charge | Energy in Charge |
| Hour | Name | Meter ID | (Wh) | Meter ID | Hour | Record (Wh) | Record (Wh) |
| 2025 Jan. 2 | Micro | micro_grid_battery | 170335.46678331154 | grid_connection | 2025 Jan. 1 | 17033.546678331154 | 25051535.2354512 |
| 21:00 | Grid | | | | 20:00 | | |
| 2025 Jan. 2 | Micro | micro_grid_battery | 522638.29254468286 | grid_connection | 2025 Jan. 1 | 52263.829254468286 | 24999271.4061967 |
| 22:00 | Grid | | | | 20:00 | | |
| 2025 Jan. 2 | Micro | micro_grid_battery | 7526866.820773019 | grid_connection | 2025 Jan. 1 | 752686.6820773019 | 24246584.7241194 |
| 23:00 | Grid | | | | 20:00 | | |
| 2025 Jan. 3 | Micro | micro_grid_battery | 2844318.9109908226 | grid_connection | 2025 Jan. 1 | 284431.89109908226 | 23962152.8330204 |
| 00:00 | Grid | | | | 20:00 | | |
| 2025 Jan. 3 | Micro | micro_grid_battery | 3268606.1032242253 | grid_connection | 2025 Jan. 1 | 326860.61032242253 | 23635292.2226979 |
| 01:00 | Grid | | | | 20:00 | | |

As can be shown in Table I, the 10% of nonrenewable and/or grid allocation is the remaining 17033.546678331154 Wh for the 2025-01-02 21:00 hour for a grid connection with meter id grid_connection earlier on 2025-01-01 at 20:00. A grid connection is not renewable energy because it may comprise energy from natural gas, oil, and/or coal. Thus, the remaining balance at the end of the 2025-01-02 21:00 hour for GC-2025-849 is 10238027.632058056 Watt-hours.

Similarly, the slice (514) for discharge hour 2025-01-02 22:00 of 522638.29254468286 Watt-hours discharged is again associated with granular certificate GC-2025-849 which again was charged on 2025-01-02 at 18:00. The discharge volume from the charge record with a 90% target green allocation is 470374.4632902146 Watt-hours, so the remaining balance at this point for GC-2025-849 is 10238027.632058056 Watt-hours less 470374.4632902146 Watt-hours or 9767653.168767842 Watt-hours. As can be shown in Table I, the 10% of nonrenewable and/or grid allocation is the remaining 52263.829254468286 Wh at 2025-01-02 22:00 for meter ID grid_connection.

Similarly, the slice (516) for discharge hour 2025-01-02 23:00 of 7526866.820773019 Watt-hours is again associated with granular certificate GC-2025-849 which again was charged on 2025-01-02 at 18:00. The discharge volume from the charge record was 6774180.138695718 Watt-hours, so the remaining balance at this point for GC-2025-849 is 9767653.168767842 Watt-hours less 6774180.138695718 Watt-hours or 2993473.0300721237 Watt-hours. As can be shown in Table I, the 10% of nonrenewable and/or grid allocation is the remaining 752686.6820773019 Wh at 2025-01-02 23:00 for meter ID grid_connection.

Similarly, the slice (518) for discharge hour 2025-01-03 00:00 of 2844318.9109908226 Watt-hours is again associated with granular certificate GC-2025-849 which again was charged on 2025-01-02 at 18:00. The discharge volume from the charge record was 2559887.0198917403 Watt-hours, so the remaining balance at this point for GC-2025-849 is 2993473.0300721237 Watt-hours less 2559887.0198917403 Watt-hours or 433586.0101803846 Watt-hours. As can be shown in Table I, the 10% of nonrenewable and/or grid allocation is the remaining 2844318.9109908226 Wh at 2025-01-03 00:00 for meter ID grid_connection.

The slice (522), (524) for discharge hour 2025-01-03 01:00 of 3268606.1032242253 Watt-hours is associated with two granular certificates: GC-2025-849 which again was charged on 2025-01-02 at 18:00 and GC-2025-850 which was charged on 2025-01-02 at 19:00. The discharge volume from GC-2025-849 (522) is 433586.01018038346 Watt-hours leaving a zero balance energy, while the discharge volume from GC-2025-850 (524) is 2508159.4827214195 Watt-hours, leaving a balance of 3883741.850809124 Watt-hours. As can be shown in Table I, the 10% of nonrenewable and/or grid allocation is the remaining 3268606.1032242253 Wh at 2025-01-03 01:00 for meter ID grid_connection.

FIG. 5B is a screenshot illustrating a first example of a discharge slice. In one embodiment, the screenshot is rendered by the energy storage management system of FIG. 2 for the energy storage device (212). For the example shown in FIG. 5B, a target green discharge allocation method is used with a 90% renewable to 10% nonrenewable ratio. In one embodiment, the slice depicted in FIG. 5B at (512 [b]) is associated with the slice (512) of FIG. 5A.

As shown in FIG. 5B, on Jan. 2, 2025 at 21:00 a discharge slice (512 [b]) had a total discharge of 170.34 kWh as also described in slice (512) in FIG. 5A. In this graph view rendering a small bar with carbon intensity 87 gCO2/kWh comprising two shaded elements are shown to represent which charge records are associated with the discharge, one from granular certificate GC-2025-849 charged January 2, 18:00 at 153.3 kWh or 90.0% of the discharge as described in (512) in FIG. 5A, and one from the Grid charged January 2, 17:00 at 17.03 kWh or 10.0% of the discharge as described in Table I.

FIG. 5C is a screenshot illustrating a second example of a discharge slice. In one embodiment, the screenshot is rendered by the energy storage management system of FIG. 2 for the energy storage device (212). For the example shown in FIG. 5C, a target green discharge allocation method is used with a 90% renewable to 10% nonrenewable ratio. In one embodiment, the slice depicted in FIG. 5C at (523 [b]) is associated with the slice (522)/(524) of FIG. 5A.

As shown in FIG. 5C, on Jan. 3, 2025 at 01:00 a discharge slice (523 [b]) had a total discharge of 3.27 MWh as also described in slice (522)/(524) in FIG. 5A. In this graph view rendering a small bar with carbon intensity 87 gCO2/kWh comprising three shaded elements are shown to represent which charge records are associated with the discharge, one from granular certificate GC-2025-849 charged January 2, 18:00 at 433.59 kWh or 13.3% of the discharge-again completely expending GC-2025-849 as described (522) in FIG. 5A, one from granular certificate GC-2025-850 charged January 2, 19:00 at 2.51 MWh or 76.7% of the discharge as described (524) in FIG. 5A, and one from the Grid charged January 2, 17:00 at 326.86 kWh or 10.0% of the discharge as described in Table I.

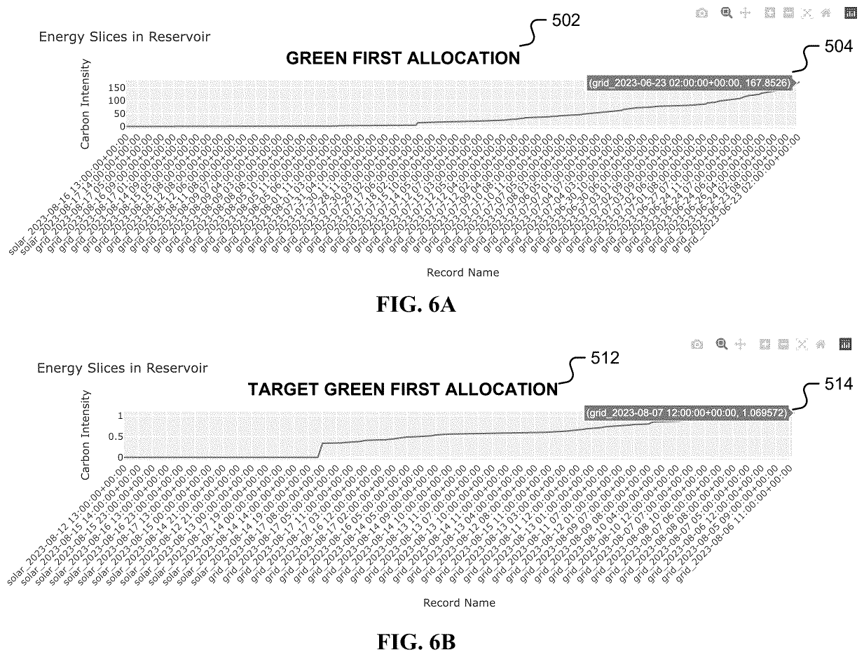

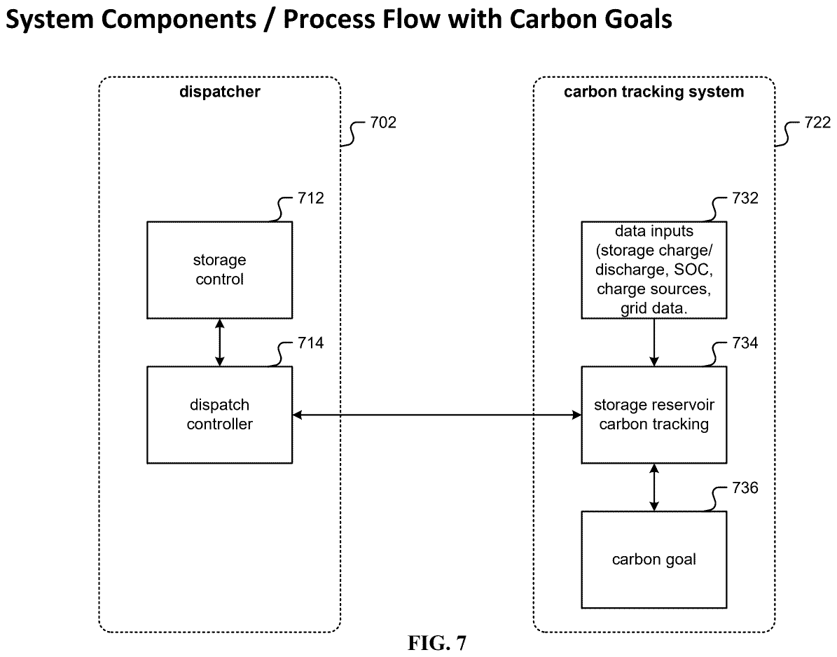

FIGS. 6A and 6B are illustrative graphs comparing two allocation strategies. In one embodiment, the graphs are based on different allocation strategies associated with the manager's input of FIG. 3.

FIG. 6A illustrates a “Green First” allocation (502) wherein any renewable charge within a battery is discharged before any nonrenewable energy is discharged. Along the horizontal axis each remaining charge record in the battery is shown in an carbon intensity ordering where the left is lower carbon intensity and the right is higher carbon intensity. Along the vertical axis the accumulated carbon intensity is graphed. As can be shown with a Green First allocation at a snapshot in time the battery has accumulated 167.8567 grams of carbon dioxide per Watt-hour (504). This is a demonstration of an exploding carbon slice with high carbon intensity. In practical applications, the exploding carbon slice problem is significant in carbon intensity within two to eight weeks.

FIG. 6B illustrates a “Target Green First” allocation (512) wherein each discharge contains 50% renewable and 50% nonrenewable energy. Again, along the horizontal axis each remaining charge record in the battery is shown in an carbon intensity ordering where the left is lower carbon intensity and the right is higher carbon intensity. Again, along the vertical axis the accumulated carbon intensity is graphed. As can be shown with a Target Green First allocation at the same snapshot in time as shown in FIG. 6A, the battery has accumulated 1.069572 grams of carbon dioxide per Watt-hour (514), which is more than 150 times lower than that shown in FIG. 6A. The Target Green First allocation is an improvement over a naïve Green First allocation as the energy slice does not explode in carbon intensity. Put another way, with the target green method, the exploding carbon slice is avoided by voluntarily discharging grey slices at certain times to ensure a grey slice does not remain with a very high carbon intensity.

For simplicity in illustration in FIG. 6B, without limitation a target ratio of 50% renewable and 50% nonrenewable is used for on a per-period basis to avoid the exploding energy slice. In one embodiment, a target ratio of 90% renewable and 10% nonrenewable is effective to avoid the exploding energy slice in many environments. Put another way, an energy storage device using target green percentages is influenced to use a discharge allocation handling non-renewable charge sources, even when solar is generating a large amount of renewable energy, to reduce the exploding slice problem.

In one embodiment, the target ratio is determined programmatically to change over each period, for example according to local sun irradiance. In this example, the sun irradiance is high at a California data center at 1:00 PM in winter, the target ratio is lowered to a lower renewable, say 0%, to a higher nonrenewable, say 100%, based at least in part on energy source planning that bypasses any grid input for local solar plant input at that time. When the sun irradiance is lower at the same winter California data center at 6:00 PM, the target ratio is programmatically raised to a higher renewable, say 100%, to lower nonrenewable, say 0%, effectively saving renewable certificates until needed at night. This target ratio is normalized to hit a specified target ratio, say 50% renewable and 50% nonrenewable, over the 24 hours of a day.

In one embodiment, the target ratio is determined programmatically to adjust according to regulatory and/or policy requirements. For example, a governmental body may in summer dictate a normalized target ratio of 90% renewable and 10% nonrenewable to avoid an exploding slice problem. If a user has manually allocated each of the 24 hour slots in FIG. 3, the target ratio is programmatically scaled/normalized to the summer regulatory ratio of 90% renewable. Further to the example, the governmental body may in winter dictate a normalized target ratio of 80% renewable and 20% nonrenewable, wherein the target ratio is scaled/normalized to the winter ratio of 80% renewable automatically on the first calendar day of winter.

In one embodiment, the target ratio is determined programmatically via machine learning and/or artificial intelligence (AI.) This machine learning is in part trained by evaluating the data center's accumulated carbon intensity and/or an accumulated carbon intensity aggregated multitenant/over multiple consumers without identifiers. The machine learning model may be periodically retrained, for example monthly and/or quarterly, to adjust for seasonal and/or regulatory changes. If a user has manually allocated each of the 24 hour slots in FIG. 3, the target ratio is then programmatically scaled/normalized to the machine learning model target ratio; otherwise a uniform or preset curved target ratio may be used over each of the 24 hour slots.

Controlling Storage and Discharge using Target Green with Dispatch. In one embodiment, a CTS system using the Target Green technique described above is combined with a dispatcher, in part to control a storage device to meet carbon goals, while the dispatcher determines the total discharge based on load requirements and/or pricing goals.

In one embodiment, control comprises: A user or system sets an hourly target of the percentage of renewables to be discharged from the storage device each hour, such as the Target Green percentage. The CTS ingests: charge data; storage device data such as the charge, discharge, and state of charge; load data; and carbon data associated with any energy supplied to the load. The CTS determines the state of the storage device reservoir with respect to renewable percentage, quantity available, carbon intensities and/or ordering of available nonrenewable slices.

In one embodiment, the CTS sends the reservoir status to the dispatcher, wherein reservoir status includes one or more of:
Total energy available and/or state of charge;
Renewable quantity available (for example in kWh);
Nonrenewable quantity available (for example in kWh);
Carbon intensity values for nonrenewable slices and/or an ordering of nonrenewable slices by carbon intensity; and/or
Storage device constraints for the next period (for example, max discharge power, min state of charge.)

FIG. 7 is a block diagram illustrating an embodiment of an energy storage management system for controlling storage and discharge to meet carbon goals. In one embodiment, one or more of the blocks in FIG. 7 may be made up of a fraction, one, or plurality of systems similar to that depicted in FIG. 1 and FIG. 2.

In one embodiment, a dispatcher (702) comprising: a storage control/interface (712) to energy storage such as a battery as shown as (212) in FIG. 2; and a dispatch controller (714) to determine in part the total discharge per load requirements and/or pricing goals for a next period:
A dispatcher may consider energy prices and/or other market signals such as predictions as one of its inputs. Forecast energy prices for the next period and/or other forecast market signals are obtained from one or more external sources separate from the CTS such as market price feeds, ISO (independent system operator) forecasts, or other relevant sources;
A dispatch controller (714) outputs a discharge command, for example kWh for the next hour and/or a kW profile for the next hour) to storage control (712) and/or directly to the storage device; and/or
A carbon tracking system CTS (722) comprising: data inputs (732) such as storage charge, discharge, SOC, charge sources (for example solar specifics or market instruments), and grid data; a storage reservoir carbon tracking module (734), and the carbon goal (736). The CTS (722) may then determine the quantity of renewables which have been discharged, and the new reservoir makeup, such as renewables vs. carbon containing slices, by applying the Target Green percentage to the total discharge. In one example configuration, for any nonrenewable portion, nonrenewable slices are discharged with the highest carbon intensity slices discharging first.

A numerical example of this, extended to include CTS input and dispatcher output, is as follows:
The data inputs (732) include that storage device associated with storage control (712) at time T1 contains 500 kWh which is 50% renewable and 50% nonrenewable. The hourly Target Green is set to 75% renewable;
ACTS reservoir tracking module (734) sends a reservoir status to a dispatch controller (714) indicating: 500 kWh total energy, 250 kWh renewable available, and 250 kWh nonrenewable available. The CTS (722) may also send the carbon intensity ordering of nonrenewable slices;
The dispatcher (702) receives a forecast energy price for the next hour from an external source, for example $150/MWh, and determines a discharge amount of 100 kWh for the next hour to meet a pricing goal;
In the given hour of interest the storage device (712) discharges 100 kWh to load. Applying the 75% renewable Target Green, the CTS (722) allocates the discharge as 75 kWh renewable and 25 kWh nonrenewable. If multiple nonrenewable slices exist, the 25 kWh nonrenewable portion may be discharged from the highest carbon intensity slices first, depending in part on dispatcher configuration;
After the discharge, and assuming there are no losses for point of clarity, the new reservoir of the storage device (734), (712) shows 400 kWh total energy, 175 kWh of which is renewable, and 225 kWh of which is nonrenewable; and/or
Optionally, expected profit for the hour is computed and stored based on the discharge command and the external price signal, for example 100 kWh at $150/MWh corresponds to $15 of gross revenue, and expected emissions are computed and stored based on the nonrenewable slices discharged.

The process and/or loop as described in FIG. 7 and above repeats at a frequency as required or necessary. At the end of each period, a CTS (722) may update the reservoir makeup and sends updated reservoir status to a dispatcher (702), and the dispatcher outputs an updated discharge command for the next period based on updated reservoir status and updated external forecast inputs. The system to carry out FIG. 7 may also be referred to as an energy storage management system as described above in FIG. 2.

Co-optimization of Goals in an Energy Storage Management System. In one embodiment, a system achieves concurrent optimization of two or more goals, for example both carbon and pricing goals, for an energy storage device and/or the one or more loads it serves. In one embodiment, a system includes a CTS and a dispatcher that exchange reservoir status and dispatch commands as described above and with FIG. 7.

For goals, a user may for example set a carbon goal and a pricing goal, with the intention of co-optimizing across both goals:
A carbon goal may comprise a mix of short-term to longer term time horizons for meeting goals;
A pricing goal may comprise commonly known economic target goals, for example a fixed rate of return, maximization of economic return, maximization of expected profit, and/or other economic objectives; and/or
Other asset goals may also be included, for example reserving a storage device reservoir to provide an emergency backup.

In one embodiment, the user or operator sets adjustable weighting variables that determine the tradeoff between the two goals, such as the pricing goal and carbon goal, for a given dispatch interval, including: a profit weight (Wp) applied to an expected profit term, and an emissions weight (We) applied to an expected emissions term and/or a penalty for not meeting a Carbon Goal. Wp and We may be adjusted by an operator on an hourly basis, or other interval, to prioritize economics or carbon over different periods. Wp and We may also be static.

For co-optimization, co-optimization may comprise optimizing for two or more goals, such as both carbon and pricing goals, which may occur simultaneously or sequentially. Tradeoffs between the two goals may be expressed as penalties for not meeting one or both goals, utilizing any of numerous known methods for co-optimizing between two goals.

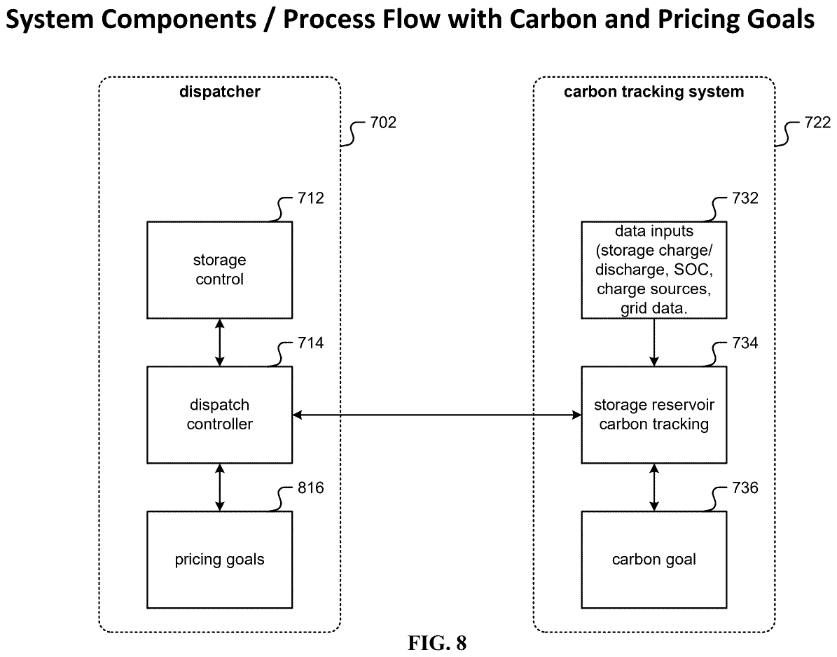

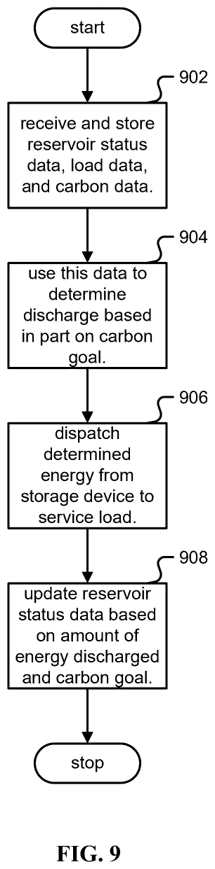

FIG. 8 is a block diagram illustrating an embodiment of an energy storage management system for controlling storage and discharge to co-optimize for carbon and pricing goals. In one embodiment, one or more of the blocks in FIG. 8 may be made up of a fraction, one, or plurality of systems similar to that depicted in FIG. 1 and FIG. 2. FIG. 8 is similar to FIG. 7 and has the same components (702), (712), (714), (722), (732), (734), and (736) with the addition of pricing goals (816).

In one embodiment, for a next time period, a dispatcher (702) selects a discharge value and/or charge value that maximizes an objective function of the form associated with one or more pricing goals (816):

$$Objective = ( Wp * Expected Profit ) - ( We * Expected Emissions ) - ( Penalties for constraints or goal violations )$$

wherein Wp is the profit weight for expected profit term, and We is the emissions weight for expected emissions term/penalty for not meeting a Carbon Goal. Expected Profit may be computed based on forecast energy prices and/or other market signals for the next period obtained from external sources separate from a CTS, which may supplement the data inputs (732). Expected Emissions may be computed using reservoir makeup information from the CTS, for example renewable vs. nonrenewable slices and carbon intensities of slices, and/or information about the load energy consumption and type from sources other than the energy storage device, and/or, forecast grid carbon intensity or forecast grid renewable percentage or CFE (Carbon Free Energy) for the next period obtained from external sources separate from the CTS in the data inputs (732). In one embodiment, co-optimization is implemented using any traditional techniques, including rule-based optimization, linear optimization, mixed-integer optimization, model predictive control, dynamic programming, or machine learned policies.

An example to illustrate numerical operator-adjustable Wp and We, assuming a reservoir state and fixed Target Green as in the previous numerical example with data inputs (732) as follows: at time T1 the storage device associated with storage control (712) contains 500 kWh which is 50% renewable and 50% nonrenewable, and the hourly Target Green is fixed at 75% renewable, and for illustrative purposes a CTS indicates the nonrenewable slices discharged first have a carbon intensity of 0.90 kg CO2/kWh.

In the example, a dispatcher receives a forecast energy price for the next hour from an external source, for example $150/MWh. If the dispatcher considers discharging 100 kWh for the next hour using dispatch controller (714), then:

$$expected profit = \$15 , or 100 kWh at \$150 / MWh ;$$

$$norenewable discharged = 25 kWh , due to 75 \% Target Green ; and / or$$

$$expected emissions = 25 kWh * 0.9 kg CO 2 / kWh = 22.5 kg CO 2.$$

If Wp=1.0 and We=$0.10/kg CO2, then:

$$Objective = ( 1. * 15 ) - ( 0.1 * 22.5 ) = \$12 \text{.75}$$

and the dispatcher may select the 100 kWh discharge.

On the other hand, if Wp=0.5 and We=$0.50/kg CO2, then:

$$Objective = ( 0 . {5}^{*} 15 ) - ( 0.5 * 22.5 ) = - \$3 \text{.75}$$

and because the Objective is negative, the dispatcher may select a lower discharge amount (including potentially 0 kWh), thereby prioritizing reduced emissions for that hour. In one embodiment, an objective function is as complex as the user describes it to be.

Co-optimization in Absence of Pre-Set Goal for Renewable Discharge. In one embodiment, elements of Target Green with dispatch and co-optimization of goals in an energy storage management system, as both described above and with FIG. 8 are further combined, where a pre-determined Target Green percentage or goal is not pre-set for the storage device discharge for a next period.

Referring back to FIG. 8, in one embodiment, where a pre-determined Target Green percentage or goal is not pre-set for the storage device discharge for a next period the following steps are performed:
a CTS (722) uses a carbon goal (736) of the load referred to herein as a load carbon goal, for example a carbon intensity or renewable percentage target;
the CTS (722) determines the current storage reservoir state (732) and sends reservoir status to the dispatcher (702)/dispatch control (714), for example: renewable quantity available, nonrenewable quantity available, carbon intensities and/or ordering of nonrenewable slices, and relevant constraints;
one or more forecast energy prices and forecast grid carbon intensity or forecast grid renewable percentage or CFE, for the next period are obtained from one or more external sources separate from the CTS (732).
either:
   the CTS (722) solves for the Target Green percentage for the next period and provides it to the dispatcher (702), for example, the CTS (722) provides a Target Green value for each of one or more candidate discharge amounts; and/or
   the dispatcher (702) solves for the Target Green percentage for the next period as part of the co-optimization.
the dispatcher (702) determines and/or executes a discharge amount/discharge range for the next period, and the CTS (722) updates its calculations and reservoir makeup; and
this loop repeats.

Thus, with multiple possible elements including a carbon goal for energy storage device/storage reservoir, a load carbon goal, and a pricing goal, tradeoffs between energy revenue and the storage carbon goal, load carbon goal, and/or the energy dispatched to a load are assessed using co-optimization.

Thus to compare with the system of FIGS. 7 and 8, in FIG. 7 the system has a Target Green dispatch percentage set and the dispatch control focuses primarily on price signals. In FIG. 8, the system has the Target Green dispatch percentage and adds a compromise of price and carbon signals. With an absence of a pre-set goal for renewable discharge, the dispatch percentage is left open for optimization along with carbon optimization and price optimization. Thus, the dispatch percentage may be dynamic with different values for different time periods and/or discharge amounts/loads and remain flexible to reach the co-optimized goals of price and carbon.

Dispatcher Example. A numerical example where the dispatcher (702) determines the Target Green percentage for the next hour is as follows: Assume from the data inputs (732) a next hour load is 200 kWh and assume a forecast grid renewable percentage or grid CFE for the next hour is 20%, obtained from an external source separate from CTS. Assume the load carbon goal is at least 50% renewable for the hour, meaning at least 100 kWh of renewable energy out of 200 kWh total. Also assume the storage device maximum discharge for the hour is 150 kWh and the reservoir contains 250 kWh renewable and 250 kWh nonrenewable at the start of the hour.

In this example, the dispatcher (702) receives a forecast energy price for the next hour from an external source separate from CTS (732), for example $150/MWh, and selects a discharge amount D and Target Green percentage TG for the next hour to co-optimize carbon and pricing goals, subject to device constraints, for example by maximizing:

$$Objective - ( Wp * Expected Profit ) - ( We * Expected Emissions ) - ( Penalties )$$

If D is the storage device (712) discharge for the hour, and TG is the Target Green percentage selected by the dispatcher (702) for that hour, then the renewable energy supplied to the load may be estimated as:

$$Renewable from grid = 0.2 * ( 200 - D ) ; and / or$$

$$Renewable from storage device = TG * D .$$

and the load carbon goal of at least 50% renewable for the hour/at least 100 kWh of renewable energy may be expressed as:

$$0.2 * ( 200 - D ) + ( TG * D ) >= 100$$

If the dispatcher (702) selects D=150 kWh, then grid supplies 50 kWh and renewable from grid is 10 kWh. The storage device supplies the remaining 90 kWh of renewable, so TG>=90/150=60%. The dispatcher (702) may therefore select D=150 kWh and TG=60% to meet the carbon goal while increasing expected profit based on the forecast energy price for the next hour, obtained from an external source separate from CTS (722). CTS (722) then allocates the discharge: 90 kWh renewable and 60 kWh nonrenewable, updates the reservoir makeup accordingly, and sends updated reservoir status to the dispatcher (702) for the next hour. For any nonrenewable portion, nonrenewable slices are discharged with the highest carbon intensity slices discharging first, in various embodiments.

CTS Example. A numerical example where the CTS (722) determines the Target Green percentage for the next hour is as follows: Assume again next hour load is 200 kWh, and assume a forecast grid renewable percentage or grid CFE for the next hour is 20%, obtained from an external source (732) separate from CTS (722). Assume again the load carbon goal is at least 50% renewable for the hour, meaning at least 100 kWh of renewable energy out of 200 kWh total. Also assume again the storage device maximum discharge for the hour is 150 kWh and the reservoir contains 250 kWh renewable and 250 kWh nonrenewable at the start of the hour.

In this example, a dispatcher (702) receives a forecast energy price for the next hour from an external source (732) separate from CTS, for example $150/MWh, and determines a candidate discharge amount D or a set of candidate discharge amounts for the next hour based on a pricing goal. The CTS then receives or otherwise obtains the candidate discharge amount D and solves for a Target Green percentage TG required to satisfy the load carbon goal, given the forecast grid renewable percentage and load, as follows:

$$Renewable from grid = 0.2 * ( 200 - D ) ;$$

$$Renewable from Storage Device = TG * D ; and / or$$

$$Carbon Goal constraint \text{:} 0.2 * ( 200 - D ) + ( TG * D ) >= 100.$$

Solving for TG gives:

$$TG >= [ 100 - 0.2 * ( 200 - D ) ] / D$$

Thus, the CTS (722) allocates a TG in proportion with a D chosen. In one embodiment, both TG and D are solved through an optimizer, based on the objective function and constraints. In one embodiment, D is solved for first, and TG is then solved sequentially

A third numerical example with multiple candidate discharge amounts continued from the previous example where CTS allocates a TG based on D: If a dispatcher proposes D=100 kWh:

$$Renewable from grid = {0.2}^{*} ( 100 ) = 20 kWh ;$$

Storage device supplies at least 80 kWh renewable; and/or
CTS computes TG using:

$$TG >= [ 100 - 0.2 * ( 200 - D ) ] / D where D = 100 kWh , or$$

$$TG >= 80 / 100 = 80 \% .$$

If the dispatcher proposes D=150 kWh:

$$Renewable from grid = 0.2 * ( 50 ) = 10 kWh ;$$

Storage device supplies at least 90 kWh renewable; and/or
CTS computes TG using:

$$TG >= [ 100 - 0.2 * ( 200 - D ) ] / D where D = 150 kWh , or$$

$$TG >= 90 / 150 = 60 \% .$$

If the dispatcher proposes D=50 kWh:

$$Renewable from grid = 0.2 * ( 150 ) = 30 kWh$$

Storage device supplies at least 70 kWh renewable; and/or
CTS computes TG using:
   TG>=[100−0.20*(200−D)]/D where D=150 kWh, or
   TG>=70/50=140% which is infeasible as TG cannot exceed 100%,
      and the CTS (722) may respond that the proposed discharge amount cannot meet the load carbon goal.

In one embodiment, a CTS (722) provides a computed Target Green percentage TG, or a feasible discharge range and corresponding TG values, to a dispatcher. In one embodiment, a dispatcher selects a discharge amount D that meets a pricing goal while satisfying a carbon goal using the CTS-provided TG, subject to device constraints.

As an illustrative example, a dispatcher (702) chooses D of 150 kWh with a CTS-provided TG of 60%. The CTS (722) then allocates the discharge as 90 kWh renewable and 60 kWh nonrenewable, updates the reservoir makeup accordingly, and sends updated reservoir status to the dispatcher for the next hour or other time period. For any nonrenewable portion, nonrenewable slices may be discharged with the highest carbon intensity slices discharging first.

System Optimization. In one embodiment, optimization uses an improvement of forecasts across input and/or output processes shown in FIG. 2, for example a forecast associated with a charge source, energy storage and/or load. A system implementing such optimization may use the Target Green method but may also use other methods such as the Co-optimization in Absence of Pre-Set Goal for Renewable Discharge as described in FIG. 8 and above.

In one embodiment, the system performs receding-horizon optimization as an example of model predictive control, over a horizon of H periods; for example, 24 to 168 hourly periods. For each period t and storage device s, the optimization determines one or more of: (i) charge power; (ii) discharge power; (iii) an hourly renewable discharge target; (iv) a certificate action (for example purchase, sale, and/or assignment) associated with one or more charge records; and/or (v) a selection of a discharge allocation rule (for example Target Green, FIFO, and/or LIFO.) The optimizer may use forecasts of load, generation, grid carbon intensity, and market prices to compute a schedule, executes the first-period setpoints, updates reservoir status and charge/discharge records based on measured outcomes, and re-solves at the next period.

In one embodiment, the optimization minimizes a weighted objective that includes expected cost and/or negative profit, expected emissions attributable to discharged energy, including via the charge record carbon intensity, and/or penalty terms for failing to satisfy a carbon goal/reliability requirement. Example objective terms include: (a) energy cost and demand charges; (b) revenue from discharge and ancillary services; (c) cost of certificates; (d) emissions/carbon-intensity penalty; and/or (e) storage degradation penalty based on throughput, cycle count, or depth-of-discharge.

In one embodiment, optimization constraints include: state-of-charge (SOC) dynamics with efficiency; charge/discharge power limits; ramp limits; minimum reserve SOC; thermal limits; warranty constraints; interconnection limits; contract constraints, for example PPA delivery limits; and/or feasibility constraints derived from reservoir composition, for example infeasible combinations of discharge amount D and Target Green TG. In one embodiment, the optimizer is implemented using linear programming, mixed-integer linear programming, dynamic programming, and/or heuristic search, and may incorporate scenarios or confidence intervals for forecasts.

Optimization steps may include, by taking in forecasts both short-term and longer-term, ranging from hourly to days:

### Charging:

1) Forecasting charge data for one or more next periods, such as with generation, including daily/seasonal forecasts which may be based on weather; and/or
2) Determining current storage device reservoir makeup and/or forecasting storage device reservoir makeup over one or more next periods;

### Loads:

3) Forecasting load over one or more next periods; and/or
4) Forecasting load renewable makeup and carbon goal scores over one or more next periods;

### Storage Device Conditions:

5) Forecasting asset conditions including state of charge, temperature, cycling rates; and/or
6) Forecasting required modalities such as reserve load, warranty requirements, and so on;

### Carbon:

7) Determining current and forecasting future grid carbon and onsite generation carbon intensity;

### Markets:

8) Determining current and forecasting future energy prices and renewable energy certificate prices, including:
   a) Adding certificates ex-post to the charging mix, updating results, and/or re-running calculations;
   b) Forecasting certificate prices to inform the disclosed herein;

### Storage Device Discharge:

9) Dynamically changing the storage device discharge method, examples including FIFO, LIFO, and/or Target Green. The % renewables per hour may also be dynamically changed. Either dynamic change may occur at end of each period over short-term, medium-term, and long-term periods, and calculations may be re-run based on a new discharge method.

Size portfolio optimization. In one embodiment, the above techniques are utilized across a portfolio of multiple assets and sites, including carbon and pricing goals based on multiple site load goals or individual goals from the portfolio. Examples include: supporting loads from multiple batteries, using a charging Power Purchase Agreement (PPA) that may be dynamically assigned across one or more batteries in a fleet, and/or directing storage device charge resources to multiple batteries across a fleet.

In one embodiment, a portfolio optimizer coordinates a plurality of storage devices and loads across multiple sites. The portfolio optimizer determines, per period, site-level charge and discharge setpoints and an allocation of renewable attributes (including certificates and charge records) across sites and/or loads. For example, the optimizer may allocate a limited quantity of renewable charging energy from a PPA or onsite generation across a fleet by selecting an assignment matrix that maps renewable energy or certificates to storage devices s and periods t, subject to contractual and temporal matching constraints and preventing double counting of certificates. In one embodiment, the portfolio optimizer uses a hierarchical architecture: a central optimizer computes portfolio allocations and sends site-level targets (for example discharge amount and Target Green), and local controllers at each site apply device constraints and update charge/discharge records and reservoir composition. The portfolio optimizer periodically re-optimizes based on measured reservoir status and updated forecasts.

In one embodiment, the portfolio objective includes one or more of: (i) minimizing portfolio-level emissions/carbon intensity; (ii) maximizing portfolio profit; (iii) minimizing cost of certificates; and/or (iv) satisfying per-site carbon targets with penalties for shortfalls. Constraints may include: site interconnection limits; PPA delivery limits; certificate eligibility rules, including location/time; minimum reserve requirements per site; and/or limits on aggregate cycling or degradation across the fleet.

In one embodiment, discharge allocations and/or discharge certificates are preferentially assigned to loads with highest marginal carbon benefit or highest shortfall relative to a carbon goal; for example, allocating renewable discharge to Load A in hours where its grid carbon intensity or compliance penalty is higher than Load B.

In one embodiment, if a dispatchable renewable source is available, for example nuclear, turbines on biogas, reciprocating engines using non fossil fuels, it may be used to optimize that dispatch as well. This may be used with existing techniques of demand response and load shifting, including data center and/or load specific techniques.

In one embodiment, a technique by which storage device discharge allocations, including the allocation of the storage device discharges and/or discharge certificates, may be allocated to one or more loads to achieve a carbon goal, including by co-optimizing with a pricing goal. These goals may be used to determine where the output of the storage device is allocated. For example, a storage device may discharge renewables to Load A which has a higher carbon intensity score during the current/next hour, and then Load B in the next hour, determined by a carbon goal or pricing goal.

In one embodiment, one storage device may charge or discharge to another storage device, for example to optimize that storage device's goals, or the goals of a load for which that storage device is connected either physically or via PPAs.

FIG. 9 is a flow diagram illustrating an embodiment of a process for tracking and controlling renewable energy storage and discharge to achieve a goal. In one embodiment, the process of FIG. 9 is carried out by the system shown in FIG. 2, FIG. 7 and/or FIG. 8.

In step (902), data is received and stored, including: reservoir status data of an energy storage device, including a state of charge and a quantity or proportion of charge from renewable energy sources; load data; and carbon data associated with energy supplied to the load. In one embodiment, the reservoir status data reflects for each of a plurality of slices of stored energy an association with renewable energy or non-renewable energy.

In step (904), the reservoir status data, load data, and carbon data is used to determine based at least in part on a carbon goal associated with the energy storage device an amount of energy to be discharged from the energy storage device to service the load. In one embodiment, the carbon goal indicates a target amount or percentage of renewable energy to be discharged per period from the storage device. In one embodiment, period is an hour. In one embodiment, the carbon goal for the energy storage device is not pre-set. In one embodiment, the carbon goal for the energy storage device is not pre-set and is optimized for a load carbon goal.

In step (906), the determined amount of energy from the energy storage device is dispatched to service the load. In step (908), the reservoir status data of the energy storage device is updated based on the amount of energy discharged from the storage device to service the load and the carbon goal. In one embodiment, the system co-optimizes based on the carbon goal and a second goal. In one embodiment, the second goal is a goal of price. In one embodiment, the second goal is a goal of price to maximize return. In one embodiment, co-optimizing comprises assigning a penalty based on an extent a goal is not achieved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An energy management system, comprising:
a memory; and
a processor coupled to the memory and configured to:
receive and store in the memory:
reservoir status data of an energy storage device, including a state of charge and a quantity or proportion of charge from renewable energy sources;
load data associated with a load; and
carbon data associated with energy supplied to the load;
use the reservoir status data, load data, and carbon data to determine based at least in part on a carbon goal associated with the energy storage device an amount of energy to be discharged from the energy storage device to service the load;
dispatch the determined amount of energy from the energy storage device to service the load; and
update the reservoir status data of the energy storage device based on the amount of energy discharged from the storage device to service the load and the carbon goal.

2. The energy management system of claim 1, wherein the carbon goal indicates a target amount or percentage of renewable energy to be discharged per period from the storage device.

3. The energy management system of claim 1, wherein the carbon goal indicates a target amount or percentage of renewable energy to be discharged per hour from the storage device.

4. The energy management system of claim 1, wherein the reservoir status data reflects for each of a plurality of slices of stored energy an association with renewable energy or non-renewable energy.

5. The energy management system of claim 1, wherein the processor is further configured to co-optimize based on the carbon goal and a second goal.

6. The energy management system of claim 1, wherein the processor is further configured to co-optimize based on the carbon goal and a second goal of price.

7. The energy management system of claim 1, wherein the processor is further configured to co-optimize based on the carbon goal and a second goal of price to maximize return.

8. The energy management system of claim 1, wherein the processor is further configured to co-optimize based on the carbon goal and a second goal, wherein co-optimizing comprises assigning a penalty based on an extent a goal is not achieved.

9. The energy management system of claim 1, wherein the carbon goal for the energy storage device is not pre-set.

10. The energy management system of claim 1, wherein the carbon goal for the energy storage device is not pre-set and is optimized for a load carbon goal.

11. The energy management system of claim 1, wherein the processor is further configured to optimize based on a forecast associated with a charge source, energy storage or load.

12. The energy management system of claim 1, wherein the processor is further configured to optimize based on a receding-horizon optimization to determine at least one of the following:
charge power; discharge power; an hourly renewable discharge target; a certificate action; and a selection of a discharge allocation rule.

13. The energy management system of claim 1, wherein the processor is further configured to optimize based on minimizing a weighted objective that includes at least one of the following:
expected cost, negative profit, expected emissions attributable to discharge energy; and penalty terms for failing to satisfy a requirement.

14. The energy management system of claim 1, wherein the processor is further configured to optimize based on constraints that includes at least one of the following: state-of-charge (SOC) dynamics with efficiency; charge/discharge power limits; ramp limits; minimum reserve SOC; thermal limits; warranty constraints; interconnection limits; contract constraints; and feasibility constraints derived from reservoir composition.

15. The energy management system of claim 1, wherein the processor is further configured to portfolio optimize across a portfolio of multiple assets and sites, comprising carbon and pricing goals based on multiple site load goals.

16. The energy management system of claim 1, wherein the processor is further configured to portfolio optimize across a portfolio of multiple assets and sites to a portfolio objective that includes at least one of the following: minimizing portfolio-level emissions; maximizing portfolio profit; minimizing cost of certificates; and satisfying per-site carbon targets with penalties.

17. A method, comprising:
receiving a reservoir status data of an energy storage device, including a state of charge and a quantity or proportion of charge from renewable energy sources;
receiving a load data associated with a load;
receiving a carbon data associated with energy supplied to a load;
using the reservoir status data, load data, and carbon data to determine based at least in part on a carbon goal associated with the energy storage device an amount of energy to be discharged from the energy storage device to service the load;
dispatching the determined amount of energy from the energy storage device to service the load; and
updating the reservoir status data of the energy storage device based on the amount of energy discharged from the storage device to service the load and the carbon goal.

18. The method of claim 17, further comprising co-optimizing based on the carbon goal and a second goal.

19. A computer program product embodied in a non-transitory computer readable medium and comprising computer instructions for:
receiving a reservoir status data of an energy storage device, including a state of charge and a quantity or proportion of charge from renewable energy sources;
receiving a load data associated with a load;
receiving a carbon data associated with energy supplied to a load;
using the reservoir status data, load data, and carbon data to determine based at least in part on a carbon goal associated with the energy storage device an amount of energy to be discharged from the energy storage device to service the load;
dispatching the determined amount of energy from the energy storage device to service the load; and
updating the reservoir status data of the energy storage device based on the amount of energy discharged from the storage device to service the load and the carbon goal.

20. The computer program product of claim 19, further comprising computer instructions for co-optimizing based on the carbon goal and a second goal.
